(19) United States
(12) Patent Application Publication
(10) Pub. No.: US 2012/0064269 A1
(43) Pub. Date: Mar. 15, 2012

(54) Multilayered Composite Plastic Material Containing an Adhesion Promoter Interlayer

(75) Inventors: Heinz Vogt, Frankfurt (DE); Harald Schmitz, Weinheim (DE); Bernd Hoecker, Wiesbaden (DE)

(73) Assignee: BASELL POLYOLEFINE GMBH, Wesseling (DE)

(21) Appl. No.: 13/250,081

(22) Filed: Sep. 30, 2011

(30) Foreign Application Priority Data
Mar. 30, 2009 (EP) 090 045 67.5
Mar. 20, 2010 (EP) PCT/EP2010/001759

(51) Int. Cl. B32B 27/32; B29C 47/06; B32B 1/02; B32B 7/02; B32B 7/12

(52) U.S. Cl. 428/35.7; 428/519; 428/213; 428/220; 428/218; 264/514

(57) ABSTRACT

A multilayered composite structure comprises at least one layer (A) consisting of an ethylene homopolymer or copolymer, at least one layer (B) comprising a barrier material and at least one layer (C) comprising an adhesion promoter material serving to improve the adhesion between these layers, wherein the adhesion promoter material comprises an adhesive polymer composition comprising a) 20 to 95% (w/w) of an ethylene homo- or copolymer which is a copolymer of ethylene with C3-C20-alkene, and b) 5 to 80% (w/w) of a polar copolymer of ethylene with at least one comonomer which comonomer is selected from the group consisting of an acrylate and acrylic acid. The composite structure can be used for fuel containers, especially fuel tanks in automotive vehicles.

The present invention relates to a novel multilayered composite structure comprising at least one layer (A) consisting of at least 90 wt.-% of an ethylene homopolymer or copolymer, at least one layer (B) comprising a barrier material and at least one layer (C) comprising an adhesion promoter material serving to improve the adhesion between these layers, and products obtained from such composite structure in the form of hollow plastic articles.

Multilayered structures comprising three, four, five and even more layers are known since many years for many applications such as hollow plastic containers. In these multilayer structures different layers most often consist of different materials which accordingly have different physical and chemical properties. Such different materials still need to be affixed by means of an intersecting adhesive layer. Such adhesive layer must mediate the bond in between the materials, both complying with their chemical properties as well as with the process employed for the preparation of the hollow plastic container by combining a multitude of layers with each others.

Polyethylene (PE), especially high-density polyethylene (HDPE), is highly suitable for extrusion blow molding of hollow articles. Such hollow articles are suitable for the storage and transport of liquid and solid materials. A special application of the hollow articles is their use for combustible liquid materials, such as fuel for automotive vehicles in automotive vehicles driven by combustion engines. As long as HDPE has a high degree of tenacity and rigidity and comprises in addition a very good processing behaviour, this polymer is widespread used to produce voluminous plastic fuel tanks saving thereby weight and space in the car.

The main draw back of PE, if compared with conventional materials of which such containers are made, such as steel, is its high permeability to non-polar liquids, such as hydrocarbons or halogenated hydrocarbons. In order to reduce hydrocarbon emission from motorvehicles, last but not least for safety purposes, the fuel tank of PE are provided with an antipermeative barrier layer. This can be effected in a chemical way by treatment of the interior surface of the container with sulfur trioxide (sulfonization) of fluorine (fluorination) or by precipitation of the polymer in a plasma (plasma polymerization). Alternatively known methods are the application of coatings of varnish or paint to the inner surface of the container or coextrusion of PE with other suitable barrier layers.

Of these various processes, coextrusion has been increasingly adopted world wide. Suitable barrier layers are mainly those of polyamides (PA) or poly(ethylene-co-vinylhydroxyde)s (EVOH) which are described by W. Daubenbüschel, “Anwendung der Coextrusion beim Extrusionsblas-formen” in Kunststoffe, 81, 894 (1991) or “Coextrudierte Kuststoffkraftstoffbehälter” in Kunststoffe, 82, 201 (1992). Polyester as another suitable barrier layer is described in EP 0 933 196.

In case of coextrusion or lamination of different layers it is important that the layers don't undergo delamination. Accordingly, a suitable adhesive must be present between the different layers which must possess excellent processing properties as well as it must retain its adhesive properties over a wide temperature range. Last but not least a suitable adhesive must not be affected by certain vibrations occurring over a long time period within a motor vehicle running over hundered of thousands miles all over the streets in the world.

EP-0 247 877 A describes an adhesive copolymer of ethylene with butyl-acrylat which was grafted with fumaric acid. Apart from its excessive adhesiveness, which make it hard to handle, it rapidly looses its adhesive strength when temperature rises. Above 60° C., it is ineffective, however.

EP-1 049 751 A describes an adhesive composition made from polar polyethylene-acrlyat copolymer blended with metallocene-produced LLDPE of MWD-1-2, which LLPDE only was grafted with maleic acid anhydride. The temperature stability of the adhesive strength of the ensuing resin still proved dissatisfactory.

It was an object of the present invention to define a multilayered composite structure having good barrier properties, if employes for fuel hollow containers, with respect to fuels comprising alcohols, but also with respect to fuels comprising biodiesel in certain amounts, and which has an excellent adhesion strength between each of its layers due to the presence of an adhesive composition that has good adhesive properties over a broad temperature range and/or on a broad range of substrate qualities and, optionally, has good processability upon blow molding extrusion.

This object is achieved by a multilayered composite structure as mentioned initially comprising as a layer (C) an adhesion promoter comprising an adhesive polymer composition comprising
a) 20 to 95% (w/w), preferably 40 to 90% (w/w) of an ethylene homo- and/or copolymer of ethylene with C₃-C₂₀-alkene, which polyethylene has a molar mass distribution width M_{w}/Mₙ of from 6 to 30, a density of from 0.93 to 0.955 g/cm³, a weight average molar mass M_{w} of from 20 000 g/mol to 500 000 g/mol, has from 0.01 to 20 CH₃/1000 carbon atoms and has at least 0.6 vinyl groups/1000 carbon atoms, and
b) 5 to 80% (w/w), preferably 10 to 60% (w/w), more preferably 20 to 45% (w/w) of a polar copolymer of ethylene with at least one comonomer which comonomer is selected from the group consisting of an acrylat and acrylic acid,
   and wherein the adhesive polymer composition comprises polymer chains which have been grafted with 0.01 to 10% of ethylenically unsaturated dicarboxylic acids and/or dicarboxylic anhydrides, based on the total weight of the adhesive polymer composition.

The ethylene homopolymers or copolymers used for layer (A) preferably possess a melt flow rate MFR (190° C./21.6 kg) according to ISO 1133 of from 1 to 20 g/10 min, more preferred form 1 to 12 g/10 min, most preferred from 2 to 10 g/10 min. The density of these polymers lies in the range of from 0.92 to 0.96 g/cm³, preferably from 0.94 to 0.957 g/cm³. The PE polymers employed for the invention are generally PE homopolymers or copolymers of ethylene with alpha-olefins comprising 3 to 10 carbon atoms. The total thickness of all the PE layers comprised in the multilayered composite structure ranges from 60 to 98%, preferably from 70 to 95% of the overall thickness of the multilayered composite structure.

If the multilayered composite structure of the instant invention forms in a particularly preferred embodiment a 6-layered structure, it comprises beside layer (A) of HDPE in addition a layer (A′) of reclaim or regrinded polymer material on the basis of HDPE and an outer layer (D) of black HDPE comprising carbon black. The outer layer (D) of black HDPE has thereby a thickness ranging of from 1 to 50%, preferably of from 3 to 30° A), of the overall thickness of the multilayered composite structure, whereas layer (A′) of reclaim or regrinded polymer material has a thickness ranging of from 20 to 60%, preferably from 25 to 50%, of the overall thickness of the multilayered composite structure. Layer (A′) of reclaim comprises usually an amount of 20 to 80% (w/w) reclaim or regrinded material which appears usually during the manufacture of HDPE articles in industrial scale and which is mixed with fresh HDPE.

The multilayered composite structure of the instant invention comprises at least one layer (B) comprising a barrier material to render the multilayered composite structure impermeable for fuel and any fuel ingredients. Such barrier material is usually composed of polyamide (PA), such as polyhexamethylene adipinic acid or poly-epsilon-caprolactame, or copolymer of ethylene with vinylhydroxide (EVOH) or polyester, such as polyethyleneterephthalate or polybutyleneterephthalate. Such polyester is usually prepared by polymerization in the presence of suitable catalysts comprising as active centre manganese, antimony or titanium. Suitable polyesters have a melt volume flow rate MVR (250° C./2.16 kg) of from 3 to 60 ml/10 min, preferably of from 5 to 40 ml/10 min. The thickness of layer (B) comprising the barrier material ranges from 1 to 10% to, preferably from 2 to 6%, of the overall thickness of the multilayered composite structure.

The overall thickness of the multilayered composite structure, especially if applied for fuel containers, especially fuel tanks in automotive vehicles, ranges from 1 to 20 mm, preferably from 2 to 15 mm, most preferred from 3 to 10 mm.

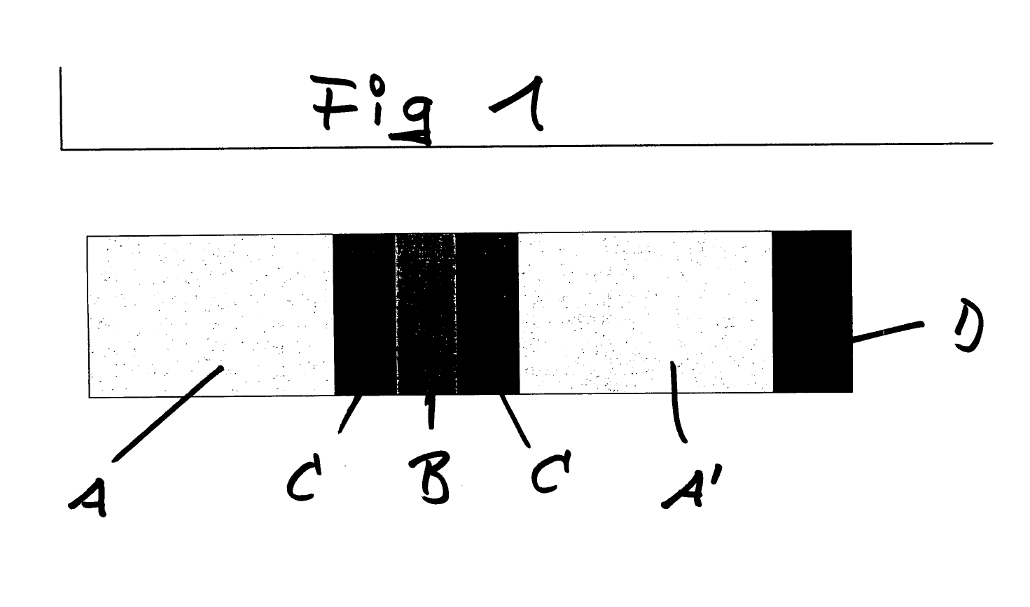

The multilayered composite structure of the instant invention may exhibit various multilayered structure, however, its most preferred embodiment comprises six layers, as is illustrated in the attached FIG. 1. This FIGURE shows how layer (B) comprising the barrier material is embedded between an inner layer (A) of HDPE and another layer (A′) of reclaim on the basis of PE, whereas an outer layer (D) of black HDPE is arranged on top of layer (A′) of reclaim. In this embodiment of the multilayered structure, two layers (C) comprising the adhesion promoter are arranged first between the inner layer (A) and layer (B) comprising the barrier material and second between layer (B) comprising the barrier material and the other layer (A′) of reclaim. The thickness of layer (C) is usually in the range of from 0.1 to 6%, preferably from 0.2 to 5%, of the overall thickness of the multilayered composite structure.

The adhesion promoter comprised in layer (C) comprising the adhesive polymer composition as mentioned before will be described in more detail as follows.

Examples of suitable C₃-C₂₀-alkenes for the adhesive polymer composition's component a) are e.g. alpha-olefins such as propene, 1-butene, 1-pentene, 1-hexene, 4-methyl-1-pentene, 1-heptene or 1-octene. The ethylene copolymer a) preferably comprises alpha-alkenes having from 4 to 8 carbon atoms in copolymerized form as comonomer unit. Particular preference is given to alpha-alkenes selected from the group consisting of 1-butene, 1-hexene and 1-octene.

The number of side chains formed by incorporation of the comonomer and their distribution, is very different when using the different catalyst systems. The number and distribution of the side chains influences the crystallization behavior of the ethylene copolymers. While the flow properties and, thus, the processability of these ethylene copolymers depends mainly on their molar mass and molar mass distribution, the mechanical properties are therefore particularly dependent on the short chain branching distribution. The crystallization behavior of the ethylene copolymers during cooling of the film extrudate is an important factor in determining how quickly and in what quality a film can be extruded. The combination of catalysts for a balanced combination of suitable mechanical properties and good processability is an important question here. Notably, with regard to vinyl group content of the ensuing copolymer, different metallocene catalysts may have different intrinsic potential.

Examples for the adhesive polymer composition's suitable copolymer of component b) are copolymers of ethylene preferably with C₁-C₁₀-alkyl-acrylate, preferably is C₁-C₆-alkyl-acrylates wherein the term ‘acrylate’ stands for an alkylester of acrylic acid and wherein preferably the alkyl is n-alkyl, such as ethyl-acrylate, n-butylacrylate, n-butyl-metacrylate. Similar to acrylate as used in the foregoing, the term acrylic acid encompasses metacrylic acid, too.

According to the present invention, a copolymer is to be understood as a co-polymer of ethylene with at least one comonomer, that is, a ‘copolymer’ according to the present invention also encompasses terpolymer and higher, multiple comonomer co-polymerizates. As opposed to a homopolymer, a co-polymer thus comprises at least more than 3.5% (w/w) of a comonomer in addition to ethylene, based on total weight of said copolymer. In a preferred embodiment though, a ‘copolymer’ is a truly binary co-polymerizate of ethylene and of substantially one species of comonomer only. The term ‘substantially one species’ preferably means that more than 97% (w/w) of comonomer amounts to one comonomer molecule.

Preferably, the adhesive polymer composition's component a) has a CDBI of 20 to 70%, preferably of less than 50%. CDBI (composition distribution breadth index) is a measure of the breadth of the distribution of the composition. This is described, for example, in WO 93/03093. The CDBI is defined as the percent by weight or mass fraction of the copolymer molecules having a comonomer contents of ±25% of the mean molar total comonomer content, i.e. the share of comonomer molecules whose comonomer content is within 50% of the average comonomer content. This is determined by TREF (temperature rising elution fraction) analysis (Wild et al. J. Poly. Sci., Poly. Phys. Ed. Vol. 20, (1982), 441 or U.S. Pat. No. 5,008,204). Optionally, it may be determined by more recent CRYSTAF analysis.

Preferably, the molar mass distribution width (MWD) or polydispersity M_{w}/Mₙ of component a) is from 8 to 20, more preferably it is 9 to 15. Definition of M_{w}, Mₙ MWD can be found in the Handbook of PE, ed. A. Peacock, p. 7-10, Marcel Dekker Inc., New York/Basel 2000. The determination of the molar mass distributions and the means Mₙ, M_{w} and M_{w}/Mₙ derived therefrom was carried out by high-temperature gel permeation chromatography using a method described in DIN 55672-1:1995-02 issue February 1995. The deviations according to the mentioned DIN standard are as follows: Solvent 1,2,4-trichlorobenzene (TCB), temperature of apparatus and solutions 135° C. and as concentration detector a PolymerChar (Valencia, Paterna 46980, Spain) IR-4 infrared detector, capable for use with TCB.

A WATERS Alliance 2000 equipped with the following precolumn SHODEX UT-G and separation columns SHODEX UT 806 M (3×) and SHODEX UT 807 connected in series was used. The solvent was vacuum destilled under Nitrogen and was stabilized with 0.025% by weight of 2,6-di-tert-butyl-4-methylphenol. The flowrate used was 1 ml/min, the injection was 500 μl and polymer concentration was in the range of 0.01%<pol. conc.<0.05% w/w. The molecular weight calibration was established by using monodisperse polystyrene (PS) standards from Polymer Laboratories (now Varian, Inc., Essex Road, Church Stretton, Shropshire, SY6 6AX, UK) in the range from 580 g/mol up to 11600000 g/mol and additionally Hexadecane. The calibration curve was then adapted to Polyethylene (PE) by means of the Universal Calibration method (Benoit H., Rempp P. and Grubisic Z., & in J. Polymer Sci., Phys. Ed., 5, 753 (1967)). The Mark-Houwing parameters used herefore were for PS: k_{PS}=0.000121 dl/g, α_{PS}=0.706 and for PE k_{PE}=0.000406 dl/g, α_{PE}=0.725, valid in TCB at 135° C. Data recording, calibration and calculation was carried out using NTGPC_Control_V6.02.03 and NTGPC_V6.4.24 (hs GmbH, Hauptstraβe 36, D-55437 Ober-Hilbersheim) respectively.

It is well-known in the art that the η₀-viscosity (zero-viscosity) of a polymer may be calculated from the weight average weight M_{w} according to η₀=M_{w} exp(3.4) a wherein a is a constant.

The blend ensuing from mixing of the adhesive polymer composition's polar component b) with the polyethylene homo- or copolymeric component a) has good mechanical properties, good processability and retains excellent adhesive properties at elevated temperatures of from 70 to 95° C. The adhesive blend of layer (C) of the present invention adheres to a wide range of surfaces that differ in chemical composition and polar or non-polar properties.

The adhesive polymer composition's polyethylene component a) of the invention has a molar mass distribution width M_{w}/Mₙ, also termed MWD or polydispersity, in the range of from 5 to 30, preferably of from 6 to 20 and particularly preferably of from 7 to 15. The density of the polyethylene a) of the invention is preferably in the range of from 0.93 to 0.955 g/cm³, more preferably of from 0.9305 to 0.945 g/cm³ and most preferably in the range from 0.931 to 0.940 g/cm³. The weight average molar mass M_{w} of the polyethylene a) of the invention is in the range of from 20 000 g/mol to 500 000 g/mol, preferably from 50 000 g/mol to 300 000 g/mol and particularly preferably from 80 000 g/mol to 200 000 g/mol.

Preferably, the z average molar mass M_{z} of the polyethylene of the invention is in the range of less than 1 Mio. g/mol, preferably of from 200 000 g/mol to 800 000 g/mol. The definition of z-average molar mass M_{z} is e.g. defined in Peacock, A. (ed.), Handbook of PE, and is published in High Polymers Vol. XX, Raff and Doak, Interscience Publishers, John Wiley & Sons, 1965, S. 443.

The HLMI of the adhesive polymer composition's polyethylene component a) is preferably in the range of from 15 to 150 g/10 min, preferably in the range of from 20 bis 100 g/10 min. For the purposes of this invention as is well known to the skilled person, the expression “HLMI” means “high load melt index” and is determined at 190° C. under a load of 21.6 kg (190° C./21.6 kg) in accordance with ISO 1133. Further with relevance to smooth, convenient extrusion behaviour at mild pressure, preferably the amount of the polyethylene of the invention with a molar mass of lower than 1 Mio. g/mol, as determined by GPC for standard determination of the molecular weight distribution, is preferably above 95.5% by weight, preferably above 96% by weight and particularly preferably above 97% by weight. This is determined in the usual course of the molar mass distribution measurement by applying the WIN-GPC software of the company 'HS-Ent-wicklungsgesellschaft für wissenschaftliche Hard-und Software mbH′, in Ober-Hilbersheim/-Germany, for instance.

Further preferred, according to the present invention, is that the adhesive polymer composition's polyethylene component a) has a substantially multimodal, preferably bimodal, distribution in TREF analysis, determining the comonomer content based on crystallinity behaviour/melting temperature essentially independent of molecular weight of a given polymer chain. A polymer chain is a single molecule constituted by covalent bonding and obtained from polymerisation of olefines, said polymer chain having a molecular weight of at least 5000. A TREF-multimodal distribution means that TREF analysis resolves at least two or more distinct maxima indicative of at least two differing branching rates and hence conomonomer insertion rates during polymerization reactions. TREF analysis analyzes comonomer distribution based on short side chain branching frequency essentially independent of molecular weight, based on the crystallization behaviour (Wild, L., Temperature rising elution fractionation, Adv. Polymer Sci. 98: 1-47, (1990), also see disclosure of U.S. Pat. No. 5,008,204). Optionally to TREF, more recent CRYSTAF technique may be employed to the same end. Typically, in a preferred embodiment of the present invention, component a) comprises at least two, preferably substantially two, different polymeric subfractions synthesized preferably by different single-site catalysts, namely a first preferably non-metallocene-one having a lower comonomer contents, a high vinyl group contents and preferably a broader molecular weight distribution, and a second, preferably metallocene one having a higher comonomer contents, a more narrow molecular weight distribution and, optionally, a lower vinyl group contents. Further preferred, typically, the numeric value for the z-average molecular weight of the first or non-metallocene subfraction will be smaller or ultimately substantially the same as the z-average molecular weight of the second or metallocene subfraction. Preferably, according to TREF analysis, the 40% by weight or mass fraction, more preferably 5 to 40%, most preferably 20% by weight of the adhesive polymer composition's polyethylene component a) having the higher comonomer content (and lower level of crystallinity) have a degree of branching of from 2 to 40 branches/1000 carbon atoms and/or the 40% by weight or mass fraction, more preferably 5 to 40%, most preferably 20% by weight of the adhesive polymer composition's polyethylene component a) having the lower comonomer content (and higher level of crystallinity) have a degree of branching of less than 2, more preferably of from 0.01 to 2 branches/1000 carbon atoms. Likewise it may be said that where the adhesive polymer composition's polyethylene component a) displays a bimodal distribution in GPC analysis, preferably the 5 to 40% by weight of the polyethylene component a) having the highest molar masses, preferably 10 to 30% by weight and particularly preferably 20% by weight, have a degree of branching of from 1 to 40 branches/1000 carbon atoms, more preferably of from 2 to 20 branches/1000 carbon atoms.

Preferably, the η(vis) value of the adhesive polymer composition's component a) is in the range of from 0.3 to 7 dl/g, more preferably of from 1 to 1.5 dl/g or optionally more preferably of from 1.3 to 2.5 dl/g. η(vis) is the intrinsic viscosity as determined according to ISO 1628-1 and -3 in Decalin at 135° C. by capillary viscosity measurement.

The adhesive polymer composition's polyethylene component a) preferably has a mixing quality measured in accordance with ISO 13949 of less than 3, in particular from 0 to 2.5. This value is based on the polyethylene taken directly from the reactor, i.e. the polyethylene powder without prior melting in an extruder. This polyethylene powder is preferably obtainable by polymerization in a single reactor. The mixing quality of a polyethylene powder obtained directly from the reactor can be tested by assessing thin slices (“microtome sections”) of a sample under an optical microscope. Inhomogenities show up in the form of specks or “white spots”. The specs or “white spots” are predominantly high molecular weight, high-viscosity particles in a low-viscosity matrix (cf., for example, U. Burkhardt et al. in “Aufbereiten von Polymeren mit neuartigen Eigenschaften”, VDI-Verlag, Düsseldorf 1995, p. 71). Such inclusions can reach a size of up to 300 μm, cause stress cracks and result in brittle failure of components. The better the mixing quality of a polymer, the fewer and smaller are these inclusions observed. The mixing quality of a polymer is determined quantitatively in accordance with ISO 13949. According to the measurement method, a microtome section is prepared from a sample of the polymer, the number and size of these inclusions are counted and a grade is determined for the mixing quality of the polymer according to a set assessment scheme.

The adhesive polymer composition's polyethylene component a) of the invention preferably has a degree of long chain branching λ, (lambda) of from 0 to 2 long chain branches/10 000 carbon atoms and particularly preferably from 0.1 to 1.5 long chain branches/10 000 carbon atoms. The degree of long chain branching λ (lambda) was measured by light scattering as described, for example, in ACS Series 521, 1993, Chromatography of Polymers, Ed. Theodore Provder; Simon Pang and Alfred Rudin: Size-Exclusion Chromatographic Assessment of Long-Chain Branch Frequency in Polyethylenes, page 254-269.

The grafting process as such is well known in the art, grafting may be applied to individual components a) or a) and b) or b), as the case may be, before blending of the components or suitably, in one preferred embodiment, directly in a one-pot reaction with the blending e.g. in an heated extruder. The reaction process of grafting is well known in the art. In a preferred embodiment, no radical starter compound such as e.g. a peroxide is employed for initiating the grafting polymerization reaction with the ethylenically unsaturated dicarboxylic acid or acid anhydride.

The adhesive polymer composition used for layer (C) can further comprise of from 0 to 6% by weight, preferably 0.1 to 1% by weight of auxiliaries and/or additives known per se, e.g. processing stabilizers, stabilizers against the effects of light and heat and/or oxidants. A person skilled in the art will be familiar with the type and amount of these additives.

In general mixing of the adhesive polymer composition's components a) and b) can be carried out by all known methods, though preferably directly by means of an extruder such as a twin-screw extruder. The extruder technique is described e.g. in U.S. Pat. No. 3,862,265, U.S. Pat. No. 3,953,655 and U.S. Pat. No. 4,001,172.

The following examples illustrate the invention without restricting the scope of the invention.

### EXAMPLES

An adhesive polymer composition for layer (C) was prepared according to example 6 of patent application PCT/EP2009-001164 filed on 18.2.2009. The blend composition was the following:
55% Polyethylen Copolymer of example 4
30% Ethylene-n-butylacrylate-Copolymer (15% n-butyl-acrylate, 85% ethylene)
15% Maleic Acid Anhydride (MA) grafted ethylene copolymer of example 4 (0.5% MA, 99.5% Copolymer)

The blend's physical properties and performance test data are compilated in Table 1, whereas the best commercial adhesion promoter based on LLDPE available under the trade name ADMER GT6E was purchased from Kuraray for comparison purposes.

| | ADMER | |
|---|---|---|
| Properties | GT6E | Exp. 1 |
| Density g/cm³ | 0.9223 | 0.9327 |
| G′- Modul measured ad | 10.3 | 10.7 |
| 0.01 (rad/s) [Pa] | | |
| MI_{(190° C./2.16 kg)} [g/10 min] | 0.97 | 1.55 |
| DSC Melting point | 118.7 | 125.4 |
| Peel strength [N/mm]* | | |
| at 23° C. | 6.8 | 7.1 |
| at 80° C. | 1.36 | 1.71 |
| Peeling mode | Cohesive | Cohesive |

*At 1 l coextruded bottles

### Preparation of Coextruded 1 l Bottles:

5(6) layer coextruded 1 l bottles have been produced by using a Krupp-Kautex KEB 8.01 blow moulding machine. Instead of regrind as an additional layer virgin LP4261AG was used. Throughput: 65 Kg/h

Wall thickness: 1.9 to 3 mm (3 mm in test area)

| | | |
|---|---|---|
| Inner layer | 29% | Lupolen 4261AG |
| Tie layer | 3% | Examples |
| Barrier layer | 4% | Eval F101A |
| Tie layer | 3% | Examples |
| “Regrind” | 40% | Lupolen 4261AG |
| Outer layer | 21% | Lupolen 4261AG |
| Σ: | 100% | |

Lupolen 4261 AG was a random copolymer of ethylene and hexene comprising 1 wt.-% hexane having a density of 0.946 g/cm³ and a HLMI of 6.0 g/10 min. The density [g/cm³] was determined in accordance with ISO 1183.

Eval F101A was an ethylene-vinlyalcohol-copolymer commercially available at Kuraray

The outer layer did comprise 2% of carbon black.

For blending, the polymer components were homogenised and granulated on a twin screw kneading machine ZSK 57 (Werner & Pfleiderer) with screw combination 8A. The processing temperature was 220° C., the screw speed 250/min with maximum output at 20 kg/h. 1500 ppm Irganox B215 were optionally added to stabilize the polyethylenes. Optional to the method of grafting the complete blend immediately after mixing in the extruder according to the method described in the examples in EP-1299 438, here component a) was split and only a minor share of component a) was grafted with maleic acid anhydride was mixed with 0.5% maleic acid anhydride and reacted separately at 200° C. (per total weight of said share to be grafted), before being put into admixture with the remainder of the polyethylene component a) and the polar acrylate component b). The dimension of the die was approximately 30 cm.

### Peel Test:

A sample of 15 mm width was cut of the side of a 1 l coextruded bottle. The T-peel test to measure the adhesive force between the outer HDPE layer and the barrier layer was performed at a peel rate of 50 mm/min. The results at 23° C. and 80° C. are indivated in table 1.

As was clearly demonstrated by the working examples, the peel strength of the adhesion promoter along with the instant invention is higher than the peel strength of the best adhesion promoter available at the market.

1. Multilayered composite structure comprising at least one layer (A) consisting of at least 90 wt.-% of an ethylene homopolymer or copolymer, at least one layer (B) comprising a barrier material, and at least one layer (C) comprising an adhesion promoter material serving to improve the adhesion between layers (A) and (B), wherein the adhesion promoter material comprises an adhesive polymer composition comprising
a) 20 to 95% (w/w) of an ethylene homo- and/or ethylene copolymer which is a copolymer of ethylene with C₃-C₂₀-alkene, which polyethylene has a molar mass distribution width M_{w}/Mₙ of from 6 to 30, a density of from 0.93 to 0.955 g/cm³, a weight average molar mass M_{w} of from 20 000 g/mol to 500 000 g/mol, from 0.01 to 20 CH₃/1000 carbon atoms, and at least 0.6 vinyl groups/1000 carbon atoms, and
b) 5 to 80% (w/w) of a polar copolymer of ethylene with at least one comonomer which comonomer is selected from the group consisting of an acrylate and acrylic acid,
and wherein the composition comprises polymer chains which have been grafted with 0.01 to 10% of ethylenically unsaturated dicarboxylic acids and/or dicarboxylic anhydrides, based on the total weight of the composition.

2. Multilayered composite structure according to claim 1, comprising an adhesive polymer composition wherein component a) is at least partially grafted with ethylenically unsaturated dicarboxylic acids and/or dicarboxylic anhydrides or, if component a) is not at least partially grafted, then the adhesive polymer composition comprises at least a third component c) in an amount of 1 to 30% (w/w), which component c) is an ethylene homopolymer and/or copolymer of ethylene with C₃-C₂₀-alkene which has a molar mass distribution width M_{w}/Mₙ of from 6 to 30, a density of from 0.92 to 0.955 g/cm³, a weight average molar mass M_{w} of from 20 000 g/mol to 500 000 g/mol, from 0.01 to 20 CH₃/1000 carbon atoms, is different from component a) and is grafted with ethylenically unsaturated dicarboxylic acids and/or dicarboxylic anhydrides.

3. Multilayered composite structure according to claim 1, wherein the ethylene homopolymers or copolymers used for layer (A) possess a melt flow rate MFR (190° C./21.6 kg) according to ISO 1133 of from 1 to 20 g/10 min and a density in the range of from 0.92 to 0.96 g/cm³ and wherein the total thickness of all layers comprising ethylene homopolymers or copolymers in said multilayered composite structure ranges from 60 to 98% of the overall thickness of the multilayered composite structure.

4. Multilayered composite structure according to claim 1, wherein the multilayered composite structure forms a 6-layered structure comprising beside layer (A) of ethylene homopolymers or copolymers (HDPE) in addition a layer (A′) of reclaim or regrinded polymer material on the basis of HDPE and an outer layer (D) of black HDPE comprising carbon black, said outer layer (D) of black HDPE having a thickness ranging of from 1 to 50% of the overall thickness of the multilayered composite structure, whereas layer (A′) of reclaim or regrinded polymer material has a thickness ranging of from 20 to 60% of the overall thickness of the multilayered composite structure.

5. Multilayered composite structure according to claim 1, wherein layer (A′) of reclaim or regrinded polymer material on the basis of HDPE comprises an amount of 20 to 80% (w/w) reclaim or regrinded material which is mixed with fresh HDPE.

6. Multilayered composite structure according to claim 1, wherein layer (B) comprises a barrier material composed of polyamide (PA) or copolymer of ethylene with vinylhydroxide (EVOH) or polyester having a melt volume flow rate MVR (250° C./2.16 kg) of from 3 to 60 ml/10 min and wherein the thickness of layer (B) comprising the barrier material ranges from 1 to 10% of the overall thickness of the multilayered composite structure.

7. Multilayered composite structure according to claim 1, wherein the overall thickness of the multilayered composite structure ranges from 1 to 20.

8. Multilayered composite structure according to claim 1, wherein component a) of the adhesive polymer composition in layer (C) has a MFR (190° C./21.6 kg) of from 0.1 to 10 g/10 min.

9. Multilayered composite structure according to claim 1, wherein component b) of the adhesive polymer composition in layer (C) is substantially a binary copolymer of ethylene and at least one alkyl-acrylate, wherein the alkyl is C₁ to C₁₀ alkyl.

10. Multilayered composite structure according to claim 1, wherein component b) of the adhesive polymer composition in layer (C) is a copolymer made from ethylene and n-butyl-acrylate.

11. Multilayered container comprising a multilayered composite structure according to claim 1.

12. A method of producing a fuel container by extrusion blow molding a multilayered composite structure according to claim 1.

13. Multilayered composite structure according to claim 1, wherein the adhesive polymer composition comprises 40 to 90% (w/w) of the ethylene homo- and/or ethylene copolymer and 10 to 60% (w/w) of the polar copolymer of ethylene with at least one comonomer.

14. Multilayered composite structure according to claim 3, wherein the ethylene homopolymers or copolymers used for layer (A) possess a melt flow rate MFR (190° C./21.6 kg) according to ISO 1133 of from 1 to 12 g/10 min, a density in the range of from 0.94 to 0.957 g/cm³, and wherein the total thickness of all layers comprising ethylene homopolymers or copolymers in said multilayered composite structure ranges from 70 to 95%.

15. Multilayered composite structure according to claim 4, wherein the outer layer (D) of black HDPE has a thickness ranging of from 3 to 30% of the overall thickness of the multilayered composite structure and layer (A′) of reclaim or regrinded polymer material has a thickness ranging from 25 to 50% of the overall thickness of the multilayered composite structure.

16. Multilayered composite structure according to claim 5, wherein layer (A′) of reclaim or regrinded polymer material on the basis of HDPE comprises an amount of 30 to 70% (w/w) reclaim or regrinded material, which is mixed with fresh HDPE.

17. Multilayered composite structure according to claim 6, wherein layer (B) includes a polyamide (PA) selected from polyhexamethylene adipinic acid or poly-epsilon-caprolactame.

18. Multilayered composite structure according to claim 6, wherein layer (B) includes a polyester selected from polyethyleneterephthalate or polybutyleneterephthalate.

19. Multilayered composite structure according to claim 6, wherein layer (B) comprises a barrier material having a melt volume flow rate MVR (250° C./2.16 kg) of from 5 to 40 ml/10 min and wherein the thickness of layer (B) comprising the barrier material ranges from 2 to 6% of the overall thickness of the multilayered composite structure.

20. Multilayered composite structure according to claim 7, wherein the overall thickness of the multilayered composite structure ranges from 2 to 15 mm.
